(19) United States
(12) Patent Application Publication
(10) Pub. No.: US 2005/0273525 A1
(43) Pub. Date: Dec. 8, 2005

(54) Dynamic I/O disabling systems and methods

(76) Inventor: David D. Anderson, McCook Lake, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/860,780

(22) Filed: Jun. 3, 2004

(51) Int. Cl. G06F 13/00

(52) U.S. Cl. 710/36

(57) ABSTRACT

A DMI includes preprogrammed including data which can be interpreted by BIOS to decide whether to enable or disable an I/O slot, e.g., an AGP slot.

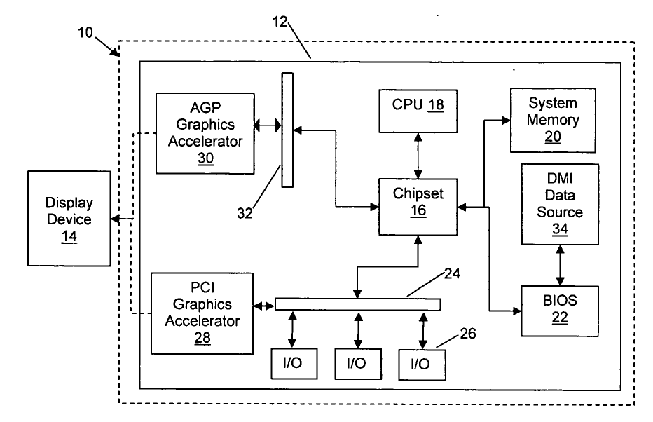

### BACKGROUND OF THE INVENTION

1. Field of the Invention

The present invention relates to devices, systems, and processes useful in I/O slot disabling, and more specifically to AGP slot disabling in a computing device.

2. Brief Description of the Related Art

AGP

Numerous graphics chips and boards for personal computers (“PC”s) have been proposed and introduced into the marketplace. Onboard graphics devices included graphics chips and memory built directly onto the motherboard. The Peripheral Component Interconnect (“PCI”) bus standard utilizes a graphics card that plugs into the PCI bus. And an Accelerated Graphics Port (“AGP”) graphics card plugs into a slot dedicated to graphics use. The AGP standard was developed as a way to enhance the performance and speed of the graphics hardware connected to a PC.

The PCI bus standard succeeded the older ISA and VL-Bus standards. The PCI bus provides direct access to the system memory of the PCT for connected devices, including graphics cards, but uses a bridge to connect to the central processing unit (CPU) of the PC. The PCI bus potentially provided higher performance than VL-Bus based devices, while possibly eliminating the potential for interference with the CPU. AGP based devices can provide even higher-performance graphics processing than PCI-based device.

Like many components in a PC, graphics cards prior to the AGP standard relied on a bus to connect to the CPU. While AGP is somewhat similar to the PCI bus, and can be referred to as the “AGP bus,” it is not actually a bus system. Instead, AGP is a point-to-point connection between components. Stated somewhat differently, the only device connecting through AGP to the CPU and system memory is the AGP graphics card, with no other stops to make on the path. Accordingly, it may not be entirely appropriate to refer to AGP as a “bus” technology, and herein the term “branch” will be used.

AGP can provide many improvements over PCI, including faster performance and direct access to system memory. One AGP standard uses a 32-bit bus with a clock rate of 66 megahertz (MHz). As there are no other devices on the AGP branch, the AGP graphics card does not have to share the branch with other devices. The graphics card is always able to operate at the maximum capacity of the connection. AGP also can use pipelining to increase speed, which organizes data retrieval into a sequential process by receiving multiple sets or chunks of data in response to a single request, rather than receiving a single set of data for each request. AGP also can use sideband addressing, which allows the graphics card to request and issue addressing information using eight additional address lines that are separate from the 32-bit path used to transfer data.

In addition to performance speed, another enhancement over PCI is that AGP-based graphics cards can directly access system memory through the AGP branch at the full speed of the branch. This can be a very important component of AGP for management for texture maps; a full discussion of texture maps and AGP-based graphics devices treatment of them are beyond the scope of this discussion, and has not been included so as not to obscure the invention.

Currently, there are three specifications of AGP: AGP 1.0; AGP 2.0; and AGP Pro. The present invention is not restricted to any particular implementation of AGP, and newer versions of AGP are within the scope of the present invention. Each of the AGP specifications is available from Intel Corp., the newest being AGP 3.0, Rev. 1.0 (September 2002), and the entireties of each of the AGP standards discussed herein is incorporated by reference.

BIOS

The basic input/output system software (“BIOS”) on a PC has a number of different roles, but a very important function is to load the operating system. When one turns on a PC and the microprocessor tries to execute its first instruction, the PC must retrieve that instruction from somewhere. The PC cannot retrieve this first instruction from the operating system, because the operating system is typically located on a hard disk, and the microprocessor cannot get to the hard disk without some instructions that tell the microprocessor how to find and address the hard disk within the system. The BIOS provides these instructions. Other common tasks that the BIOS performs include: a power-on self-test (POST) for each of the hardware components in the system to assure that each is working properly; activating other BIOS chips on different cards installed in the computer (e.g., SCSI and graphics cards often have their own BIOS chips); and providing a set of low-level routines that the operating system uses to interface with different hardware devices (from which BIOS derives its name). These low-level routines manage devices such as the keyboard, the display device, and the serial and parallel ports, in particular when the computer is booting. The BIOS is typically stored on a flash memory chip on the motherboard, but may also be located on another type of ROM.

When a PC is powered up, the BIOS typically performs several functions. A usual sequence can include:

Check the CMOS Setup for custom settings

Load the interrupt handlers and device drivers

Initialize registers and power management

Perform the POST

Display system settings

Determine which devices are bootable

Initiate the bootstrap sequence

The first step performed by BIOS is to check the information stored in a small (64 bytes) amount of RAM located on a complementary metal oxide semiconductor (CMOS) chip. The CMOS Setup provides detailed information particular to the PC and can be altered as the PC is modified. The BIOS uses this information to modify or supplement its default programming as needed. Interrupt handlers are small pieces of software that act as translators between the hardware components and the operating system. Device drivers are other pieces of software that identify the base hardware components such as keyboard, mouse, hard drive, and floppy drive. As the BIOS is constantly intercepting signals to and from the hardware, it is usually copied, or shadowed, into RAM to run faster.

After checking the CMOS Setup and loading the interrupt handlers, the BIOS determines whether the video card is operational. Many video cards have a miniature BIOS of their own that initializes the memory and graphics processor on the card. Otherwise, there is typically video driver information on another ROM on the motherboard that the BIOS can load. The BIOS then checks to see if this is a cold boot or a reboot, checks the PS/2 ports or USB ports for a keyboard and a mouse, looks for a PCI bus and, if it finds one, checks all the PCI cards installed in the PCI bus. If the BIOS finds any errors during the POST, it typically causes the PC to sound a series of beeps or display a text message on the PC screen. The BIOS then usually displays some details about the PC on the screen, typically including information about the processor, the removable media drives, system memory, BIOS revision and date, and the display.

Any special drivers, such as ones for small computer system interface (SCSI) adapters, are loaded from the adapter, and the BIOS displays the information. The BIOS then looks at the sequence of storage devices identified as boot devices in the CMOS Setup and will serially try to initiate the boot sequence from the first device.

DMI

SMBIOS (System Management BIOS, SMBIOS) is a specification addressing how motherboard and system vendors display management information about their products in a standard format. DMI (Desktop Management Interface, DMI) is a system that helps to collect information about computers. DMI information can only be collected under SMBIOS specification. Both SMBIOS and DMI specifications are drafted by the Desktop Management Task Force (DMTF; c/o Kavi Corporation, Portland, Oreg.), an industry-led organization that implements technology specifications to ensure open standards. DMI is intended to perform on any platform and operating system, to act as the interface between management utility and system components. DMI creates a standard computer system that is easily understood by computer manufacturers and users. A main component of DMI is Management Information Format database (“MIF”), which contains all of the information about the particular computing system (e.g., PC) and its components. Through DMI, users can obtain information about a particular PC, including serial number, computer manufacturer, serial port information, as well as other system component information.

DMI can be thought of as a framework for managing and keeping track of hardware and software components in a system of personal computers, e.g. from a central location. DMI is hardware and operating system-independent, independent of specific management protocol, mappable to existing management protocols such as the Simple Network Management Protocol (SNMP), and used on network and non-network computers. DMI includes at least four components: Management Information Format (“MIF”), service layer, Component interface (“CI”), and Management interface (“MI”).

MIF is a text file that contains specific information about the hardware and software being used on a computer. An MIF file includes of one or more groups containing attributes, which describe each component in the PC. By default, each MIF file contains the standard component ID group, which contains the product name, version, serial number, and the time and date of the last installation. An ID number is assigned based on when the component was installed in relation to other components. Manufacturers can create their own MIFs specific to a component. This information is then sent to an MIF database.

The service layer is memory-resident code that acts as a mediator for the management interface and the component interface and allows management and component software to access MIF files in the MIF database. The service layer is available as an operating system add-on and is a shared resource for all programs. The service layer also includes a common interface called the local agent, which is used to manage individual components.

The CI is an application program interface (API) that sends status information to the appropriate MIF file via the service layer. Commands include the Get and Set command that modifies the MIF as needed and the Event command that notifies management software of critical events. The MI software communicates with the service layer using the MI application program interface. The MI allows administrators to issue the Get and Set command and the List command that lists all the DMI-manageable devices.

One difficulty with the use of AGP branches on a motherboard is that many component providers require that an AGP slot be disabled in certain circumstances. For a computer manufacturer that builds PCs with and without AGPs, this presents a difficulty in how to configure the motherboard when the manufacturer builds different models of PCs using only a single motherboard. That is, using a single motherboard configuration that includes an AGP slot, such a manufacturer encounters difficulties in using this one motherboard configuration both for PCs that will not use the AGP slot, and/or for which the AGP slot must be disabled, and for PCs that will use the SGP slot. There remains a need for a fast, reliable, and cost-effective way for a motherboard including an AGP slot (and associated architecture) to be used without the AGP slot, e.g., for the AGP slot to be disabled.

### SUMMARY OF THE INVENTION

According to a first aspect of the invention, a system for selectively enabling and/or disabling an I/O slot of a motherboard comprises a motherboard, a BIOS operationally supported by said motherboard, an I/O slot, a data source comprising at least one code in communication with and readable by said BIOS, means to enable or disable said I/O slot, and said BIOS including logic configured and arranged to selectively enable or disable said I/O slot with said means to enable or disable based on a value of said code.

According to another aspect of the present invention, a system for selectively enabling and/or disabling an I/O slot of a motherboard comprises a motherboard, BIOS means operationally supported by said motherboard, I/O means, data source means comprising code means in communication with and readable by said BIOS means, means for enabling or disabling said I/O means, and said BIOS means for selectively enabling or disabling said I/O means with said means to enable or disable based on a value of said code means.

According to yet another aspect of the present invention, a process for selectively enabling and/or disabling an I/O slot of a motherboard comprises reading at least one code stored in a data source by a BIOS, and enabling an I/O slot when said at least one code indicates that said I/O slot is to be enabled, or disabling said I/O slot when said at least one code indicates that said I/O slot is to be disabled.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which the one drawing figures illustrates first exemplary embodiments of both systems and methods in accordance with the present invention.

### DETAILED DESCRIPTION OF THE PREFERRED EMBODIMENTS

Referring to the drawing figures, like reference numerals designate identical or corresponding elements throughout the several figures.

In general terms, one aspect of the present invention includes preprogramming DMI information to include data concerning a variable which can be interpreted by BIOS to decide whether to enable or disable an I/O slot. By way of a non-limiting example, the BIOS routine reads the DMI and determines if the system requires that the I/O slot, preferably an AGP slot, be disabled, by reading a variable, identifier, or the like, e.g., the series name of the computer system, preprogrammed into DMI. When BIOS reads the information in DMI, BIOS determines if the system requires that the AGP slot be disabled, based on the value of the variable, identifier, or the like. If disabling the I/O slot is not needed, BIOS sets up the AGP slot for use in the computer. If disabling the I/O slot is required, BIOS does not enable the slot.

Turning now to the drawing figure, exemplary embodiments of systems and methods according to the present invention will now be described. A computing device 10, a non-limiting example of which is a PC, includes a motherboard 12, and is attached through appropriate cabling to a display device 14, e.g., a CRT or LCD monitor. The motherboard 12 includes, and provides appropriate functioning interconnectivity between: a chipset 16; a CPU 18; a system memory 20; and a BIOS 22. As the skilled artisan is well-acquainted with the layout and construction of motherboard 12 and it's numerous components, these details will not be provided herein so as not to obscure the present invention.

A PCI bus 24 is provided by which one or a plurality of PCI-based I/O devices 26 can be placed in communication with the other components of the motherboard 12. Additionally, the PCI bus 24 can accommodate a PCI-based graphics accelerator card 28, which in turn can be connected to the display device 14 in a known manner.

As discussed elsewhere herein, the motherboard 12 can also be provided with an AGP branch and slot 32 to receive an appropriately configured AGP graphics accelerator 30. When the AGP graphics accelerator 30 is provided, it is no longer necessary, to provide the PCI-based graphics accelerator card 28, and the card 28 is preferably not included and the AGP graphics accelerator 30 is instead connected to the display device 14.

The BIOS is in communication with a DMI data source 34 which includes information about the computer 10, as described elsewhere herein. One aspect of the present invention includes that the DMI data source 34 includes data indicative of the type or series of the computing device 10, and more specifically whether or not the I/O device of interest, e.g., the AGP bus and slot 32, is to be enabled. While the DMI data source 34 can be physically and logically located in any of numerous locations, one aspect of the present invention is that the DMI data source is contained within the BIOS code. The ‘I/O device enable’ data stored in the DMI data source 34 can be contained in any field of the DMI structure as specified by the system BIOS, and any parameter may be used as the ‘I/O device enable’ data as specified by the system BIOS.

This ‘I/O-device enable’ data, preferably ‘AGP-device enable’ data, is read by BIOS 22 during the boot sequence. While the ‘AGP-device enable’ data can be in any one of numerous positions within the BIOS sequence, another aspect of the present invention includes that the ‘AGP-device enable’ data be read by BIOS before any VGA BIOS or the like is loaded into memory.

The BIOS 22 includes logic configured to interpret this ‘AGP-device enable’ data and to enable the AGP branch and bus 32 and accelerator 30 when the ‘AGP-device enable’ data indicates that the series of the computing device is to be enabled for AGP. The BIOS 22 logic is also configured to interpret this ‘AGP-device enable’ data and to not enable the AGP branch and bus 32 and accelerator 30 when the ‘AGP-device enable’ data indicates that the series of the computing device is not to be enabled for AGP. The present invention is not limited to enabling and disabling an AGP device by a BIOS 22, and extends to enabling (or not) other components of or connected to the motherboard 12 and/or computing device 10 based on data contained in a DMI data source 34 that is (or are) indicative of, and interpreted by BIOS, a predefined configuration of the computing device.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A system for selectively enabling and/or disabling an I/O slot of a motherboard comprising:
a motherboard;
a BIOS operationally supported by said motherboard;
an I/O slot;
a data source comprising at least one code in communication with and readable by said BIOS;
means to enable or disable said I/O slot; and
said BIOS including logic configured and arranged to selectively enable or disable said I/O slot with said means to enable or disable based on a value of said code.

2. A system according to claim 1, wherein said I/O slot comprises an Advanced Graphics Adapter.

3. A system according to claim 1, wherein said data source comprises a Desktop Management Interface, and said at least one code comprises a Desktop Management Interface parameter value.

4. A system according to claim 1, wherein said data source is stored on said motherboard.

5. A system for selectively enabling and/or disabling an I/O slot of a motherboard comprising:
a motherboard;
BIOS means operationally supported by said motherboard;
I/O means;
data source means comprising code means in communication with and readable by said BIOS means;
means for enabling or disabling said I/O means; and
said BIOS means for selectively enabling or disabling said I/O means with said means to enable or disable based on a value of said code means.

6. A system according to claim 1, wherein said I/O means comprises an Advanced Graphics Adapter.

7. A system according to claim 1, wherein said data source means comprises a Desktop Management Interface, and said code means comprises a Desktop Management Interface parameter value.

8. A system according to claim 1, wherein said data source means is stored on said motherboard.

9. A process for selectively enabling and/or disabling an I/O slot of a motherboard comprising:
reading at least one code stored in a data source by a BIOS; and
enabling an I/O slot when said at least one code indicates that said I/O slot is to be enabled, or disabling said I/O slot when said at least one code indicates that said I/O slot is to be disabled.

10. A process according to claim 9, wherein said BIOS is operationally supported by a motherboard.

11. A process according to claim 9, wherein said I/O slot comprises an Advanced Graphics Adapter.

12. A process according to claim 9, wherein said data source comprises a Desktop Management Interface, and said at least one code comprises a Desktop Management Interface parameter value.

13. A process according to claim 9, wherein said data source is stored on said motherboard.
